(19) United States
(12) Patent Application Publication
(10) Pub. No.: US 2008/0225790 A1
(43) Pub. Date: Sep. 18, 2008

(54) Method and System for Operating Ultra Wideband Network in the Presence of Another Network

(76) Inventor: Yefim Kupershmidt, Or Yehuda (IL)

Correspondence Address: RECHES PATENTS, 211 NORTH UNION STREET, SUITE 100, ALEXANDRIA, VA, 22314, US

(21) Appl. No.: 11/381,323

(22) Filed: May 2, 2006

(51) Int. Cl. H04Q 11/06

(52) U.S. Cl. 370/330

(57) ABSTRACT

A method for ultra wideband transmission and an ultra wideband device. The ultra wideband device includes a receiver that is connected to a controller; wherein the receiver is adapted to receive a transmission from a component of the non-ultra wideband network; wherein the controller is adapted to: (i) allocate a first frequency band for a transmission of at least a portion of an ultra wideband network super-frame that comprises at least one short silence period; (ii) allocate a second frequency band for a transmission of at least another portion of an ultra wideband network super frame; wherein the length of the silence period is longer than a link establishment period required for establishing a link between components of a non-ultra wideband network that utilize multiple frequencies within the first frequency band; and (iii) alter an allocation of frequency bands in response to the reception of the transmission from the component of the non-ultra wideband network.

### FIELD OF THE INVENTION

The invention relates to methods and apparatus for operating an ultra wideband network while allowing another network to operate.

### BACKGROUND

Various ultra wideband transmitters and transmission techniques are known in the art. The following U.S. patents and patent applications, all being incorporated herein by reference, illustrate a number of such devices and methods:
a. U.S. patent application publication number 2005/282514 of Kang et al.;
b. U.S. patent application publication number 2005/237966 of Aiello et al.;
c. U.S. patent application publication number 2005/0018762 of Aiello et al.;
d. U.S. patent application publication number 2005/0041725 of DeRivaz et al.;
e. U.S. patent application publication number 2005/0083896 of Hong et al.;
f. U.S. patent application publication number 2004/105515 of Mo et al. and
g. U.S. Pat. No. 6,668,008 of Panasik.

Ultra wideband networks enable multiple devices to exchange information by exchanging ultra wideband transmissions. These transmissions can prevent other networks from establishing a communication link. These other networks usually use more narrow bandwidths, but these relatively narrow bandwidths can overlap the bandwidth of ultra wideband transmission. A typical such narrow bandwidth network is a Wi-Max network that requires a silent period of about 50 milliseconds (approximately each 250 milliseconds) in order to establish a link.

Merely blanking ultra wideband transmissions for 50 milliseconds each 250 milliseconds is unacceptable for most applications. Thus, there is a need to enable an ultra wideband network and another network to co-exist.

### SUMMARY OF THE INVENTION

A method for ultra wideband transmission, the method includes: allocating a first frequency band for a transmission of at least a portion of an ultra wideband network super-frame that includes at least one short silence period; allocating a second frequency band for a transmission of at least another portion of an ultra wideband network super frame; wherein the length of the silence period is longer than a link establishment period required for establishing a link between components of a non-ultra wideband network that utilize multiple frequencies within the first frequency band; and altering an allocation of frequency bands in response to a reception of a transmission from a component of the non-ultra wideband network.

Conveniently, the first and second frequency bands belong to the same frequency band group. Conveniently, the link establishment period exceeds 49 mili-seconds.

Conveniently the altering includes stopping the allocation of the first frequency band, especially after receiving a transmission from a component of the non-ultra wideband network.

Conveniently the allocating is followed by transmitting frequency information representative of the frequency allocation.

Conveniently the frequency information comprises a ratio between the number of ultra wideband network super-frames that are transmitted using the first frequency band and the second frequency band.

Conveniently at least one beacon frame of the second ultra wideband super-frame is transmitted using the first frequency band while at least one or PCA DRP frame of the second ultra wideband super-frame is transmitted using the second frequency band.

An ultra wideband device that includes a receiver connected to a controller; wherein the receiver is adapted to receive a transmission from a component of the non-ultra wideband network; wherein the controller is adapted to: (i) allocate a first frequency band for a transmission of at least a portion of an ultra wideband network super-frame that includes at least one short silence period; (ii) allocate a second frequency band for a transmission of at least another portion of an ultra wideband network super frame; wherein the length of the silence period is longer than a link establishment period required for establishing a link between components of a non-ultra wideband network that utilize multiple frequencies within the first frequency band; and (iii) alter an allocation of frequency bands in response to the reception of the transmission from the component of the non-ultra wideband network.

Conveniently the controller is adapted to stop the allocation of the first frequency band after the reception of the transmission from the component of the non-ultra wideband network.

Conveniently the device includes a transmitter adapted to transmit frequency information representative of the frequency allocation.

Conveniently the frequency information comprises a ratio between the number of ultra wideband network super-frames that are transmitted using the first frequency band and the second frequency band.

Conveniently the transmitter is adapted to transmit at least one beacon frame of the second ultra wideband super-frame using the first frequency band while transmitting at least one DRP or PCA frame of the second ultra wideband super-frame using the second frequency band.

### BRIEF DESCRIPTION OF THE DRAWINGS

The present invention will be understood and appreciated more fully from the following detailed description taken in conjunction with the drawings in which:

FIG. 1 is a schematic illustration of an ultra wideband network and another network according to an embodiment of the invention.

FIG. 2 illustrates the multiple band groups allocated for ultra wideband transmission;

FIG. 3 illustrates two super-frames according to an embodiment of the invention;

FIGS. 4 and 5 illustrate five super-frames according to an embodiment of the invention;

FIGS. 6-7 illustrate a device capable of wireless transmission, and some of its components, according to an embodiment of the invention; and

FIG. 8 is a flow chart of a method for ultra wideband transmission, according to an embodiment of the invention.

### DETAILED DESCRIPTION

Some portions of the following description relate to wireless ultra wideband networks that utilize a distributed media access control scheme. In these ultra wideband networks there is no central media access controller, but rather various devices of the ultra wideband network participate in determining how to share a common wireless medium.

Various operations such as transmissions utilize the distributed media access control scheme in the sense that the access to a shared medium is governed by a distributed media access control scheme.

According to various embodiments of the invention a silence period is defined. During this silence period the components of an ultra wideband network do not transmit in a certain frequency. The length of the silence period is defined such as to allow an establishment of a link by a non-ultra wideband network. It is noted that a super-frame can include different frames (such as PCA frames) that are transmitted at different frequencies.

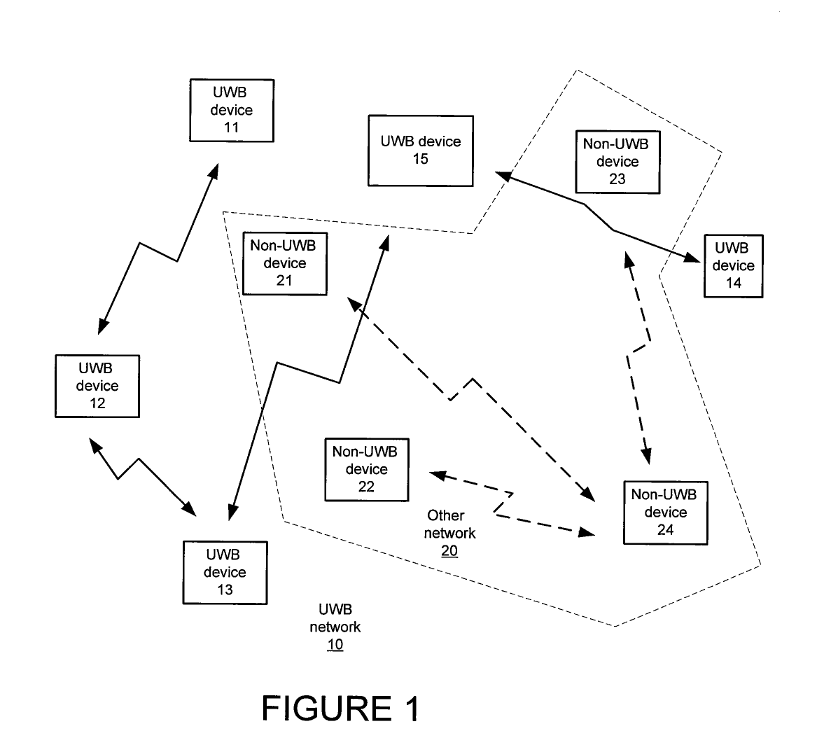

FIG. 1 is a schematic illustration of an ultra wideband network 10 and another network 20 according to an embodiment of the invention.

It is noted that FIG. 1 not to scale and that the reception range of components of the ultra wideband network can differ from the reception range of components of the non-ultra wideband network. Usually (but not necessarily) the reception range of the components of ultra wideband network is smaller and even much smaller than the reception range of components of the non-ultra wideband network.

Ultra wideband (UWB) network 10 includes UWB devices (or components) 11, 12, 13, 14 and 15. Another network (a non-ultra wideband network) 20 includes non-UWB devices (or components) 21, 22, 23 and 24. It is noted that the arrangement of each network can differ from the arrangement shown in FIG. 1. For example, the number of devices as well as their location can change.

FIG. 1 illustrates a distributed UWB network in which each UWB device transmits to the other device, while the other network includes a central device (non-UWB device 24) that exchanges information with the other devices (21, 22 and 23).

At least one device of the non-ultra wideband (non-UWB) network (also referred to as other network) 20 is within the transmission area of the UWB network 10. Thus, the transmission of the UWB network 10 can interfere with the transmission of the other network 20. Furthermore, the transmissions of the UWB network 10 can prevent the devices of the other network from establishing a link.

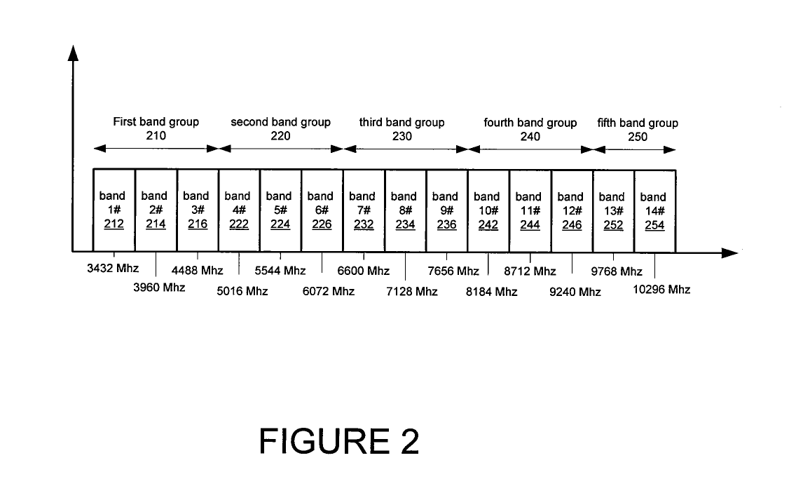

FIG. 2 illustrates the multiple band groups 210-250 allocated for ultra wideband transmission. The first band group 210 includes the first till third bands 212-216. The second band group 220 includes the fourth till sixth bands 222-226. The third band group 230 includes the seventh till ninth bands 232-236. The fourth band group 240 includes the tenth till twelfth bands 242-246. The fifth band group 250 includes the thirteenth and the fourteenth bands 252 and 254. Each band is 528 Mhz wide. The center frequencies of these bands are: 3432 Mhz, 3960 Mhz, 4488 Mhz, 5016 Mhz, 5544 Mhz, 6072 Mhz, 6600 Mhz, 7128 Mhz, 7656 Mhz, 8184 Mhz, 8712 Mhz, 9420 Mhz, 9768 Mhz and 10296 Mhz.

An ultra wideband device, such any of devices 11-15, can perform one out of several pre-defined fast frequency hopping sequences. Each fast frequency hopping sequence is limited to frequencies within a single band group. These fast frequency hopping sequence can involve altering the frequency each one or more symbols. These fast frequency hopping sequences do not allow to open a 50 mili-second silence window.

According to an embodiment of the invention the UWB network performs slow frequency hopping between one frequency band to another. The slow frequency hopping defines a long silence window of at least 50 mili-seconds. During this long silence window the UWB network members can transmit at another one or more frequency band within the group of frequency bands allocated to the UWB network.

Conveniently, the slow frequency hopping includes altering the frequency band used for a transmission of one super-frame.

The slow hopping is enables by sending frequency information representative of the slow frequency hopping pattern. This frequency information can determine the ration between super-frames that are transmitted using a first frequency band and the super-frame that is transmitted using a second frequency band. This frequency information can determine the frequency band used for transmitting the next one or more super-frame.

Ultra wideband devices exchange information by using super-frames. A super frame includes multiple frames (time-slots) during which devices of the ultra wideband network can exchange information. A super-frame usually includes one or more beacon frames as well as multiple media access frames. The media access frames include distributed reservation protocol (DRP) frames and prioritized contention access (PCA) frames.

The beacon frames are used to synchronize devices to the super-frame. A typical beacon frame includes information that identifies the transmitting device. It also may include timing information representative of the start time of the super-frame. The DRP frames are coordinated between devices that belong to the same ultra wideband network and allow devices to reserve these frames in advance. During the PCA frames devices that belong to the ultra wideband network compete for access based upon their transmission priority. It is noted that the allocation of media access frames is dynamic and can change from one super-frame to another.

Typically, transmissions from devices during PCA frames are assigned by applying a carrier sense multiple access with collision avoidance (CSMA/CA) scheme If a device requests to transmit over a wireless medium it has to check if the wireless medium is idle. If the wireless medium is idle, the device has to wait a random backoff period. This random backoff time is selected from a contention window that has a length that is related to the priority of the device. For higher-priority devices the contention window is shorter.

Conveniently, the frequency information is included within the beacon frames.

Conveniently, the super-frames includes DRP silence periods during which the members of the UWB do not transmit but try to detect a transmission from the other network. If such a transmission is detected then the USB network can be forced to use another frequency band.

It is noted that the frequency information can be sent in various ways, including sending dedicated messages, synchronization and the like. Conveniently, a transmitter includes frequency information representative of the selected slow frequency sequence within each information super-frame he sends.

Conveniently, time frequency code representative of the lack of fast frequency hopping can be provided in various manners, such as but not limited to an inclusion within an information frame PLCP preamble.

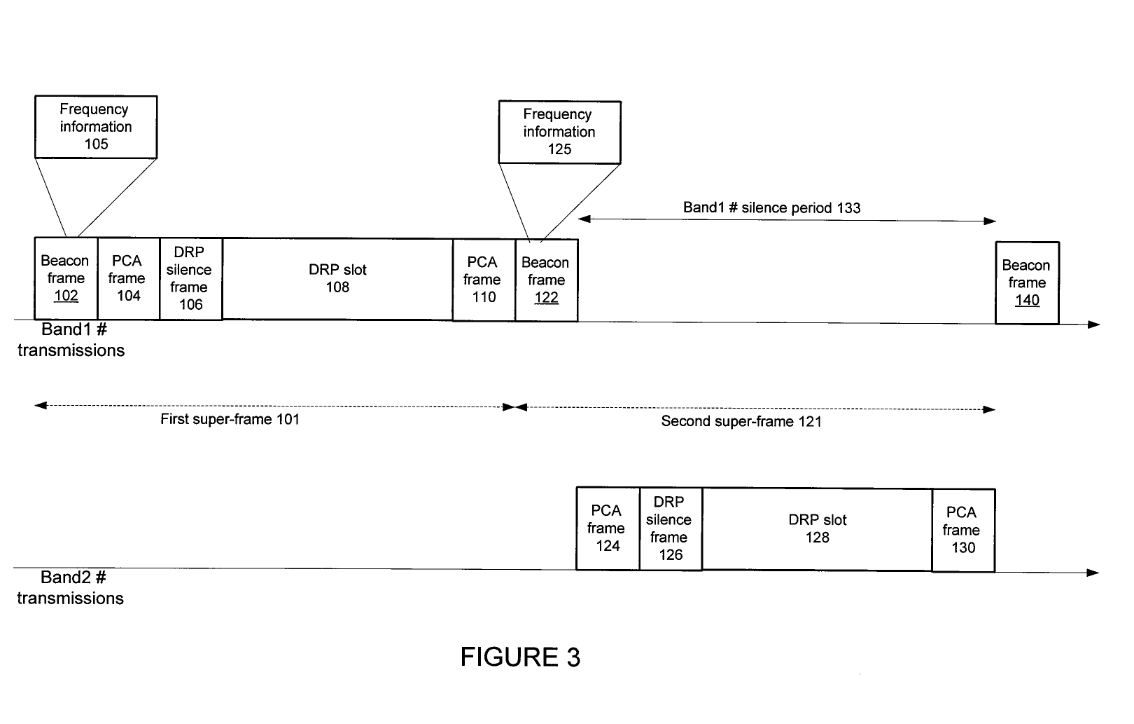

FIG. 3 illustrates two super-frames according to an embodiment of the invention. The first super-frame 101 includes a beacon frame 102, PCA frame 104, DRP silence period 106, DRP slot 108 and PCA frame 110. These frames are transmitted using a first frequency band 212. The second super-frame 121 includes a beacon frame 122, as well as additional PCA and DRP frames collectively denoted “PCA, DRP frames” 123. They include PCA frame 124, DRP silence period 126, DRP slot 128 and PCA frame 130. The beacon frame 122 is transmitted using a first frequency band 212 while the other frames 124-130 are transmitted using the second frequency band 214.

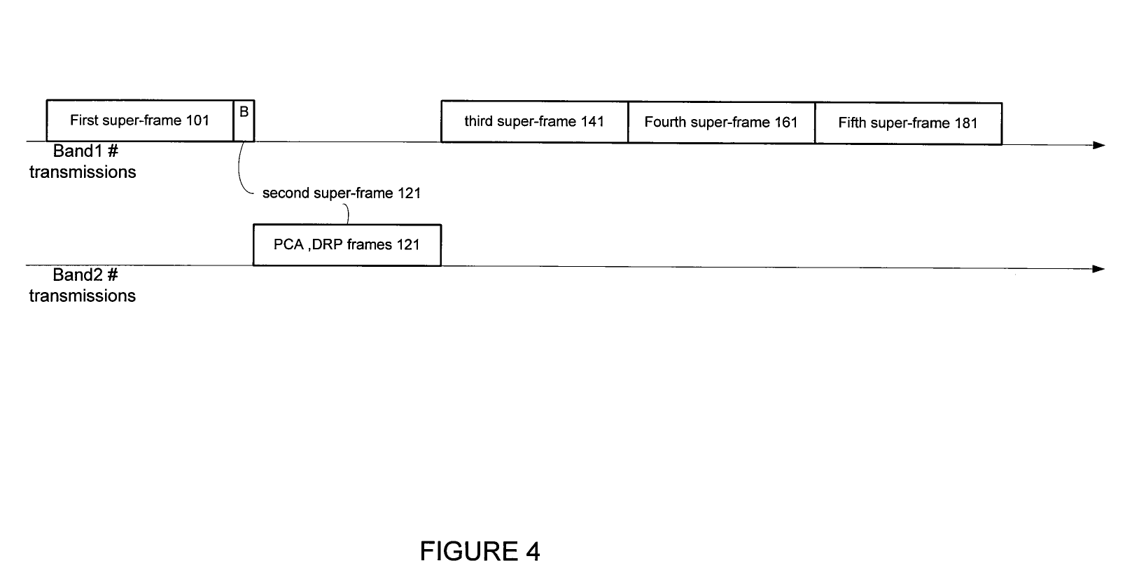

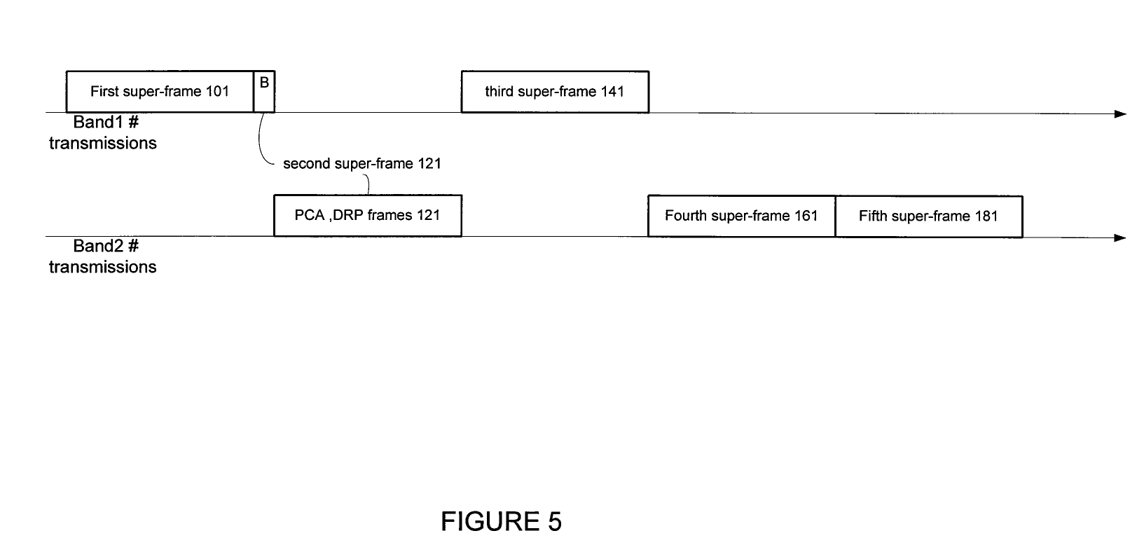

The third super-frame 143 (of FIGS. 4 and 5) starts by a beacon frame 140 and is transmitted using the first frequency band 212.

The DRP silence periods 106 and 126 are allocated for listening for transmissions of the other network. During these frames the UWB devices are silent.

FIGS. 4 and 5 illustrate five super-frames 101-181, according to an embodiment of the invention.

FIG. 4 illustrates a scenario in which a first super frame 101 is transmitted using the first frequency band 212, most of the second super frame 121 is transmitted using the second frequency band 214, the third till fifth super-frames are transmitted using the first frequency band 212. During the sequence it is assumed that the UWB devices did not receive a transmission of the other network, especially during the DRP silence periods allocated for listening to possible transmissions of the other network.

FIG. 5 illustrates a scenario in which a first super frame 101 is transmitted using the first frequency band 212, most of the second super frame 121 is transmitted using the second frequency band 214 and the third super-frame 141 is transmitted using the first frequency band 212. It is assumed that during a DRP silence period within the third super-frame 143 transmissions of the other network are received. These transmissions use multiple frequencies within the first frequency band 212. Accordingly, after the third super-frame ends the UWB devices transmit using the second frequency band.

Some embodiments of the invention provide an ultra wideband wireless medium access control method and a device capable of performing ultra wideband wireless medium access control schemes.

Conveniently, the device is a part of a ultra wideband wireless network and has a communication protocol stack that includes at least a PHY layer and a MAC layer. The MAC layer of such devices controls the access to ultra wideband wireless medium and is referred to ultra wideband wireless medium access control.

Examples of devices that have a PHY layer are illustrated in the following U.S. patent applications, all being incorporated herein by reference: U.S. patent application Ser. No. 10/389,789 filed on Mar. 10, 2003 and U.S. patent application Ser. No. 10/603,372 filed on Jun. 25, 2003.

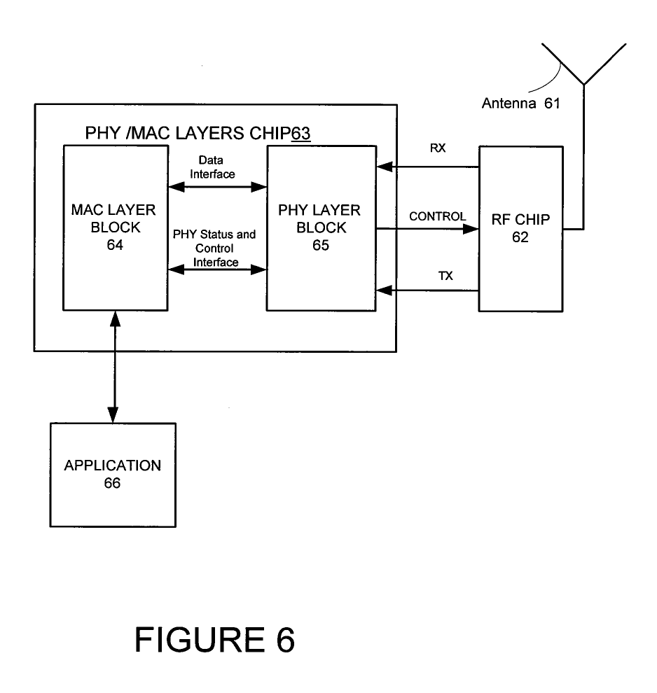

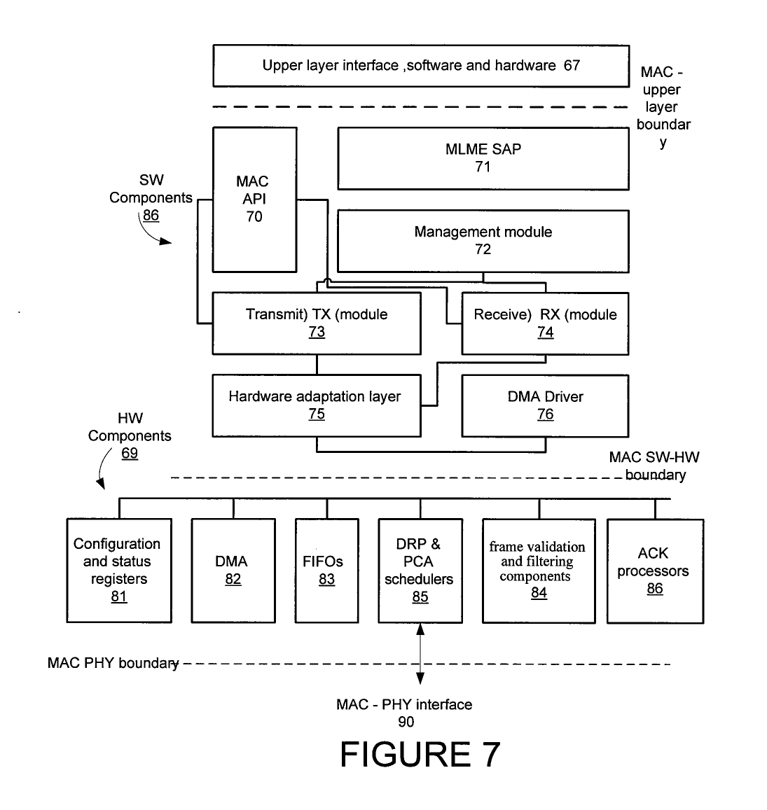

The receiver can include various components that are arranged in multiple layers. A first configuration includes a frame convergence sub-layer, a MAC layer, a PHY layer as well as MAC SAP, PHY SAP, frame convergence sub-layer SAP and a device management entity can also be utilized. Another configuration is described at FIGS. 6 and 7.

Wisair Inc. of Tel Aviv Israel manufactures a chip set that includes a Radio Frequency PHY layer chip and a Base-Band PHY layer chip. These chips can be connected in one end to a RF antenna and on the other hand be connected or may include a MAC layer circuitry.

FIG. 6 illustrates a device 60 that is capable of wireless transmission, according to an embodiment of the invention.

Device 60 includes antenna 61 that is connected to a RF chip 62. RF chip 62 is connected to a MAC/PHY layers chip 63 that includes a PHY layer block 63 and a MAC layer block 64. The MAC/PHY layers chip 63 is connected to an application entity 66 that provides it with information to be eventually transmitted (TX) and also provides the application 66 with information received (RX) by antenna 61 and processed by PHY and MAC layers blocks 68 and 69 of FIG. 5.

The MAC layer block 64 acts as a controller that can determine frequency allocations.

Typically, the MAC layer block 64 controls the PHY layer block using a PHY status and control interface. The MAC and PHY layers exchange information (denoted TX and RX) using PHY-MAC interface 90. The RF chip 62 provides to the PHY layer block 63 received information that is conveniently down-converted to base band frequency. The RF chip 62 receives from the PHY layer block 63 information to be transmitted as well as RF control signals. The application 66 is connected to the MAC/PHY layers chip 63 by a high speed I/O interface.

FIG. 7 illustrates various hardware and software components of the MAC/PHY layers chip 63, according to an embodiment of the invention.

The Upper Layer IF block 64 of the MAC/PHY layers chip 63 includes hardware components (collectively denoted 69) and software components (collectively denoted 68). These components include interfaces to the PHY layer (MAC-PHY interface 90) and to the application (or higher layer components).

The hardware components 69 include configuration and status registers 81, Direct Memory Access controller 82, First In First Out (FIFO) stacks 83 and frame validation and filtering components 84, DRP and PCA slots schedulers 85, ACK processors 86, and MAC-PHY internal interface 87.

The software components 68 include a management module 72, transmit module 73, receive module 74m hardware adaptation layer 75, DMA drivers 76, MAC layer management entity (MLME) service access point (SAP) 71, MACS API 70 and the like.

These software and hardware components are capable of performing various operations and provide various services such as: providing an interface to various layers, filtering and routing of specific application packets sent to MAC data queues or provided by these queues, performing information and/or frame processing, and the like.

The routing can be responsive to various parameters such as the destinations of the packets, the Quality of Service characteristics associated with the packets, and the like.

The processing of information along a transmission path may include: forming the MAC packet itself, including MAC header formation, aggregation of packets into a bigger PHY PDU for better efficiency, fragmentation of packets for better error rate performance, PHY rate adaptation, implementation of Acknowledgements policies, and the like.

The processing of information along a reception path may include de-aggregation and/or de-fragmentation of incoming packets, implementation of acknowledgment and the like.

The hardware components are capable of transferring data between MAC software queues and MAC hardware (both TX and RX), scheduling of beacons slots, scheduling of DRP and PCA access slots, validation and filtering (according to destination address) of incoming frames, encryption/ decryption operations, low-level acknowledgement processing (both in the TX path and in the RX path),

Device 60 can be a simple device or even a complex device such as but not limited to a multimedia server that is adapted to transmit information frames of different types to multiple devices. It can, for example transmit Streaming data, like voice, Video, Game applications, etc.) data files during DRP slots, and while PCA slots transmits video over IP frames, download MP3 files, download MPEG-2 files, and stream or download MPEG-4 streams.

Usually, voice frames are associated with higher quality of service requirements and accordingly are given higher transmission priorities. The voice frames QoS requirements are followed by video frames that in turn are followed by lower quality of service requirements (lower priority transmission) frames such as best effort frames and background frames.

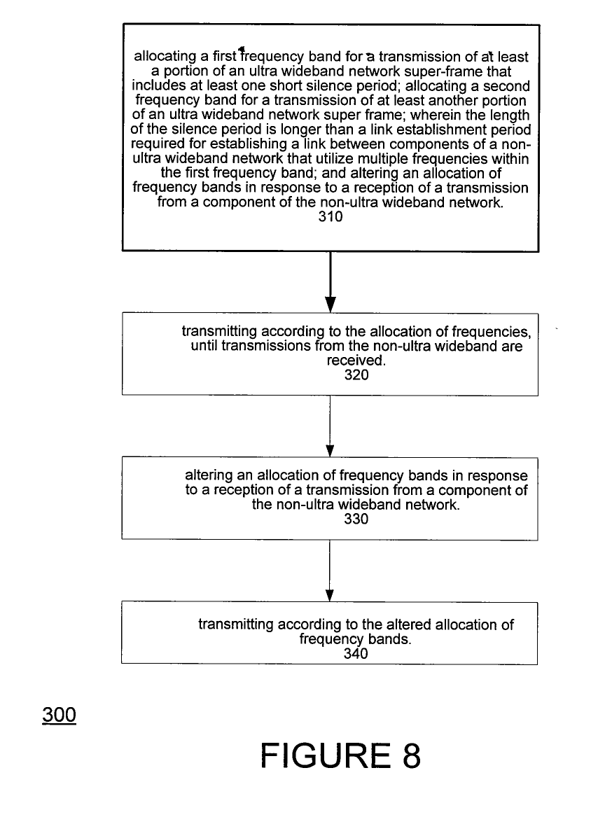

FIG. 8 is a flow chart of method 300 for ultra wideband transmission, according to an embodiment of the invention.

Method 300 starts by stage 310 of allocating a first frequency band for a transmission of at least a portion of an ultra wideband network super-frame that comprises at least one short silence period, and allocating a second frequency band for a transmission of at least another portion of an ultra wideband network super frame; wherein the length of the silence period is longer than a link establishment period required for establishing a link between components of a non-ultra wideband network that utilize multiple frequencies within the first frequency band.

Conveniently, the first and second frequency bands belong to the same frequency band group.

Conveniently, the link establishment period exceeds 49 mili-seconds.

It is noted that the portions allocated for transmission at the first frequency and at the second frequency can belong to the same super-frame but this is not necessarily so. For example, a certain super-frame can include PCA frames that should be transmitted using the first frequency and also include one or more other DRP frames that should be transmitted using the second frequency.

Stage 310 is followed by stage 320 of transmitting according to the allocation of frequencies, until transmissions from the non-ultra wideband are received.

Conveniently, stage 320 includes transmitting frequency information representative of the frequency allocation.

Conveniently, stage 320 includes transmitting frequency information that includes a ratio between the number of ultra wideband network super-frames that are transmitted using the first frequency band and the second frequency band.

Conveniently, stage 320 includes transmitting at least one beacon frame of the second ultra wideband super-frame using the first frequency band and transmitting at least one DRP frame of the second ultra wideband super-frame using the second frequency band.

Stage 320 is followed by stage 330 of altering an allocation of frequency bands in response to a reception of a transmission from a component of the non-ultra wideband network.

Conveniently, the altering includes stopping the allocation of the first frequency band.

Stage 330 can be followed by stage 340 of transmitting according to the altered allocation of frequency bands.

Accordingly, the above disclosed subject matter is to be considered illustrative and not restrictive, and to the maximum extent allowed by law, it is intended by the appended claims to cover all such modifications and other embodiments, which fall within the true spirit and scope of the present invention.

The scope of the invention is to be determined by the broadest permissible interpretation of the following claims and their equivalents rather then the foregoing detailed description.

What is claimed is:

1. A method for ultra wideband transmission, the method comprises: allocating a first frequency band for a transmission of at least a portion of an ultra wideband network super-frame that comprises at least one short silence period; allocating a second frequency band for a transmission of at least another portion of an ultra wideband network super frame; wherein the length of the silence period is longer than a link establishment period required for establishing a link between components of a non-ultra wideband network that utilize multiple frequencies within the first frequency band; and altering an allocation of frequency bands in response to a reception of a transmission from a component of the non-ultra wideband network.

2. The method of claim 1 wherein the first and second frequency bands belong to the same frequency band group.

3. The method according to claim 1 wherein the link establishment period exceeds 49 mili-seconds.

4. The method according to claim 1 wherein the altering comprises stopping the allocation of the first frequency band.

5. The method according to claim 1 wherein the allocating is followed by transmitting frequency information representative of the frequency allocation.

6. The method according to claim 5 wherein the frequency information comprises a ratio between the number of ultra wideband network super-frames that are transmitted using the first frequency band and the second frequency band.

7. The method according to claim 1 wherein the allocating is followed by transmitting at least one beacon frame of the second ultra wideband super-frame using the first frequency band and transmitting at least one DRP frame of the second ultra wideband super-frame using the second frequency band.

8. An ultra wideband device that comprises a receiver coupled to a controller; wherein the receiver is adapted to receive a transmission from a component of the non-ultra wideband network; wherein the controller is adapted to: (i) allocate a first frequency band for a transmission of at least a portion of an ultra wideband network super-frame that comprises at least one short silence period; (ii) allocate a second frequency band for a transmission of at least another portion of an ultra wideband network super frame; wherein the length of the silence period is longer than a link establishment period required for establishing a link between components of a non-ultra wideband network that utilize multiple frequencies within the first frequency band; and (iii) alter an allocation of frequency bands in response to the reception of the transmission from the component of the non-ultra wideband network.

9. The device of claim 8 wherein the first and second frequency bands belong to the same frequency band group.

10. The device according to claim 8 wherein the link establishment period exceeds 49 mili-seconds.

11. The device according to claim 8 wherein the controller is adapted to stop the allocation of the first frequency band.

12. The device according to claim 8 further comprising a transmitter adapted to transmit frequency information representative of the frequency allocation.

13. The device according to claim 12 wherein the frequency information comprises a ratio between the number of ultra wideband network super-frames that are transmitted using the first frequency band and the second frequency band.

14. The device according to claim 8 wherein the transmitter is adapted to transmit at least one beacon frame of the second ultra wideband super-frame using the first frequency band while transmitting at least one DRP frame of the second ultra wideband super-frame using the second frequency band.
